(19) United States
(12) Patent Application Publication
(10) Pub. No.: US 2015/0355514 A1
(43) Pub. Date: Dec. 10, 2015

(54) TRANSPARENT DISPLAY DEVICE AND DISPLAYING METHOD THEREOF

(71) Applicant: Chunghwa Picture Tubes, Ltd., Taoyuan (TW)

(72) Inventors: Ji-Nian Lin, Yilan County (TW); Chien-Hua Chen, Changhua County (TW); Chun-Wei Su, New Taipei City (TW)

(21) Appl. No.: 14/476,718

(22) Filed: Sep. 3, 2014

(30) Foreign Application Priority Data
Jun. 6, 2014 (TW) 103119789

(51) Int. Cl. G02F 1/1362; G09G 3/36; G02F 1/1335

(52) U.S. Cl. CPC G02F 1/136209; G02F 1/133514; G02F 1/133512; G02F 1/133602; G09G 3/3607; G09G 3/3648; G02F 2001/136222; G09G 2300/0809; G09G 2300/0478; G09G 2300/0456; G09G 2320/0666

(57) ABSTRACT

A transparent display device includes a first active LCD panel, a second active LCD panel and a backlight module sandwiched between the first active LCD panel and the second active LCD panel. Both of the first active LCD panel and the second active LCD panel can provide various images and show different displaying states. Therefore, the transparent display device can utilize the images or the displaying states shown by the second active LCD panel to facilitate the image displaying function of the first active LCD panel to achieve the purpose of improving the image contrast and the variety effect.

### BACKGROUND OF THE INVENTION

1. Field of the Invention

The present invention relates to a transparent display device and a displaying method thereof, and more particularly to a transparent display device which can achieve improved image-displaying effect and a displaying method thereof.

2. Description of the Prior Art

Transparent display devices refer to display devices including transparent displaying and image displaying functions, and which can be generally applied to a billboard, a video game machine and a showcase. There are plenty of display panel technologies that can be used in the transparent display device, and the liquid crystal display (LCD) panel is one of mature technologies among them and the related technologies thereof that continue to flourish in the industry.

In generally, for improving the variability and the diversity of the images displayed by the display panel, the pixel electrodes consisting of the sub pixels of RGB color model can be used to achieve the color displaying function by adjusting the RGB combination. However, in order to maintain the transparent displaying function, the transparent display device is limited by the arrangement of the pixel electrodes, such that the light transmittance and the image resolution thereof may be easily affected. In addition, the transparent display devices nowadays are usually a passive display device which displays static images, so that the images displayed therefrom are monotonous and lacking in variation, thereby affecting the displaying quality of the images.

Thus, there is a need in the art to provide an improved transparent display device to overcome the aforementioned issues.

### SUMMARY OF THE INVENTION

It is one of the primary objectives of the present invention to provide a transparent display device, which can provide various images and displaying states, with such performance to improve the overall image displaying function.

To achieve the purpose described above, a preferred embodiment of the present invention provides a transparent display device, including a first active liquid crystal display (LCD) panel, a second active LCD panel and a backlight module, wherein the backlight module is sandwiched between the first active LCD panel and the second active LCD panel. The first active LCD panel includes a color filter substrate; a first thin film transistor (TFT) substrate disposed opposite to the color filter substrate; and a first polymer dispersed liquid crystal (PDLC) layer, disposed between the color filter substrate and the first thin film transistor substrate. The second active LCD panel includes a substrate; a second TFT substrate, disposed opposite to the substrate; and a second PDLC layer, disposed between the substrate and the second TFT substrate.

To achieve the purpose described above, a preferred embodiment of the present invention also provides a displaying method for a transparent display device, comprising the following steps. Firstly, the aforementioned transparent display device is provided. The first active LCD panel of the aforementioned transparent display device is used to show a color image or a transparent state. Also, the second active LCD panel of the aforementioned transparent display device is used to show a partial grayscale image, a full grayscale image, or a transparent state.

Through the present invention, the transparent display device of the present invention is mainly characterized in the cooperation of the first display panel and the second display panel. The first active LCD panel and the second active LCD panel can show different images or different displaying states, respectively, with the images or displaying state shown by the second active LCD panel facilitating the images shown by the first active LCD panel to achieve the purpose of improving the image contrast and the variety effect. In addition, since both of the images shown by the first active LCD panel and the second active LCD panel can be a dynamic image, such as a dynamic color image or a dynamic grayscale image, the images displayed by the transparent display device of the present invention can be more diverse.

### BRIEF DESCRIPTION OF THE DRAWINGS

FIG. 1 is a schematic exploded view illustrating a transparent display device according to one preferred embodiment of the present invention.

FIG. 2 is a schematic side view illustrating a transparent display device according to one preferred embodiment of the present invention.

FIG. 3 is a partial schematic diagram illustrating a transparent display device according to one preferred embodiment of the present invention.

FIG. 4 is a partial schematic diagram illustrating another transparent display device according to another preferred embodiment of the present invention.

FIG. 5 is a diagram illustrating a displaying method of a transparent display device according to one embodiment of the present invention.

FIG. 6 is a diagram illustrating a displaying method of a transparent display device according to one embodiment of the present invention.

FIG. 7 is a diagram illustrating a displaying method of a transparent display device according to one embodiment of the present invention.

FIG. 8 is a diagram illustrating a displaying method of a transparent display device according to one embodiment of the present invention.

FIG. 9 is a diagram illustrating a displaying method of a transparent display device according to one embodiment of the present invention.

FIG. 10 is a diagram illustrating a displaying method of a transparent display device according to one embodiment of the present invention.

### DETAILED DESCRIPTION

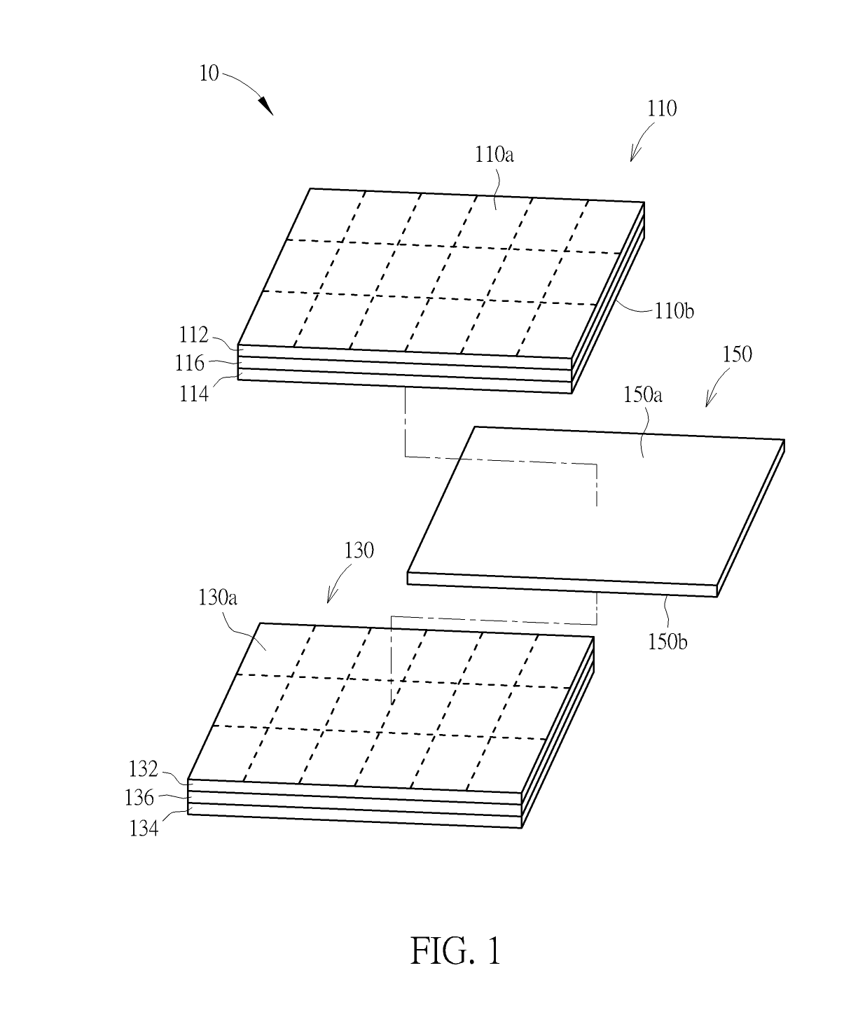

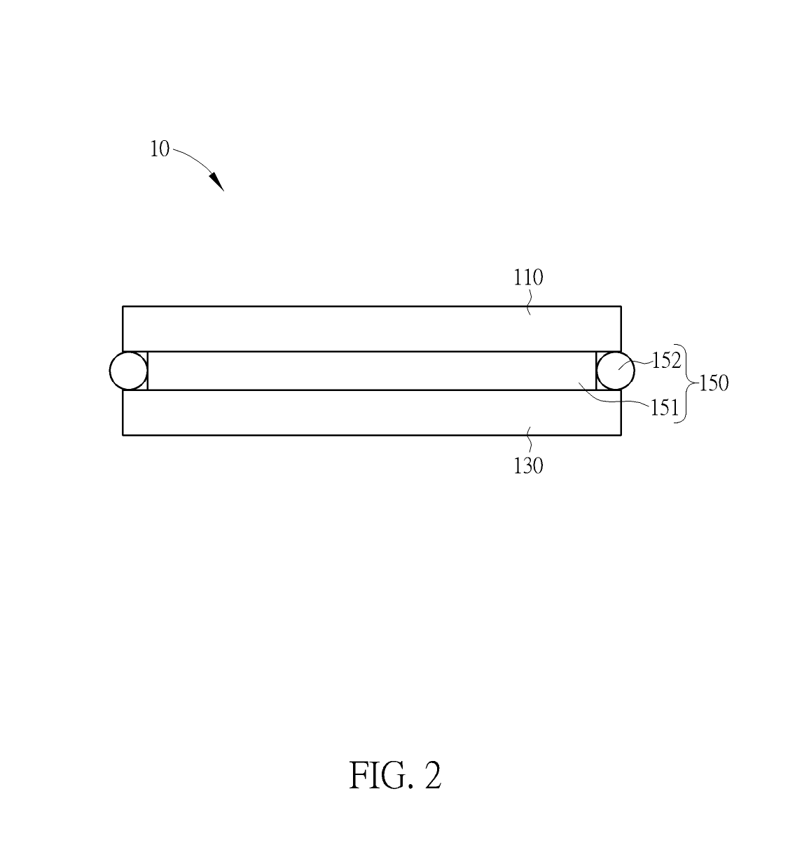

Referring to FIGS. 1 and 2, a transparent display device 10 includes a first display panel 110, a second display panel 130 and a backlight module 150 sandwiched between the first display panel 110 and the second display panel 130. The first display panel 110 has a display surface 110a and a back surface 110b opposite to the display surface 110a, and the first display panel 110 bonds to a first side 150a of the backlight module 150 via the back surface 110b; the second display panel 130 also has a display surface 130a, and the second display panel 130 bonds to a second side 150b of the backlight module 150 via the display surface 130a.

The first display panel 110 and the second display panel 130 can be a transmissive display panel or another display panel having light transmittance effect, preferably a liquid crystal display (LCD) panel. In the present embodiment, an active liquid crystal display panel is exemplified as the first display panel 110 and the second display panel 130, but the present invention is not limited thereto.

The first display panel 110 includes a first substrate 112 (defined as a top substrate), a second substrate 114 (defined as a bottom substrate) disposed opposite to the first substrate 112, and a first dielectric layer 116 filled between the first substrate 112 and the second substrate 114. The first substrate 112 and the second substrate 114 can be attached to each other via a sealant (not shown in the drawings) to maintain a fixed space therebetween. The first substrate 112 is disposed at the side of the display surface 110a, such that the material of the first substrate 112 may include a light transmitting material, such as glass, plastic or quartz. The material of the substrate 114 may include a light transmitting material and/or an opaque material. In the present embodiment, the first substrate 112 may include a color filter substrate, and the second substrate 114 may include a thin film transistor (TFT) substrate, but not limited thereto. In addition, the material of the first dielectric layer 116 may include polymer dispersed liquid crystal (PDLC), cholesteric liquid crystal (CLC) or other suitable materials, preferably the PDLC having low driving voltage and high image contrast, such as 4-benzene liquid crystal. On the other hand, the arrangements and the composed materials of the second display panel 130 are substantially the same to that of the first display panel 110, and the second display panel 130 includes a third substrate 132 (defined as a top substrate), a fourth substrate 134 (defined as a bottom substrate) disposed opposite to the third substrate 132, and a second dielectric layer 136 filled between the third substrate 132 and the fourth substrate 134. The materials of the third substrate 132 and the fourth substrate 134 are substantially the same as the materials of the first substrate 112 and the second substrate 114, and which will not be redundantly described. In the present embodiment, the fourth substrate 134 can include a TFT substrate, but not limited thereto.

Furthermore, the backlight module 150 may further include a transparent light guide plate 151 and a light source 152. The light source 152 is at least disposed at one side of the transparent light guide plate 151. Wherein, the transparent light guide plate 151 may include a transparent material, such as acrylic resin or plastic, and the light source 152 may include light emitting diode (LED) or other suitable component which can provide light source to provide enough light in a low-light environment or at night. In another embodiment, the light source 152 can also be omitted, however.

In the present embodiment, both of the first display panel 110 and the second display panel 130 are an active transparent LCD panel, and preferably an active PDLC display panel. Preferably, the active PDLC display panel includes PDLC having a low driving voltage and high image contrast, such as 4-benzene liquid crystal, wherein the PDLC includes a PDLC composition and 20% to 50% of polymerized material, for example including organic solvent, polyether polyol acrylic monomer, acrylic resin monomer, polymercaptan, and photoinitiator. Thus, the driving voltage of the transparent display device 10 of the present invention can be maintained at around 4 eV to 6 eV, preferably at 5 eV. Preferably, the first display panel 110 and the second display panel 130 can be a color transparent display panel and a monochrome transparent display panel respectively, for example, the first display panel 110 being a color transparent display panel and the second display panel 130 being a monochrome transparent display panel; or the first display panel 110 being a monochrome transparent display panel and the second display panel 130 being a color transparent display panel, but not limited thereto. In another embodiment, the first display panel 110 and the second display panel 130 may both be color transparent display panels or both be monochrome transparent display panels, simultaneously. The display surface 110a of the first display panel 110 can be defined as an image display side of the transparent display device 10 of the present invention, and the images or displaying states shown from the first display panel 110 and the second display panel 130 can be both observed through the image display side. With such arrangement, the various images, such as color images, full grayscale images or partial grayscale images, and a transparent state shown by the second display panel 130 can be used to facilitate the images shown by the first display panel 110 to achieve the purpose of improving the image contrast and variety effect.

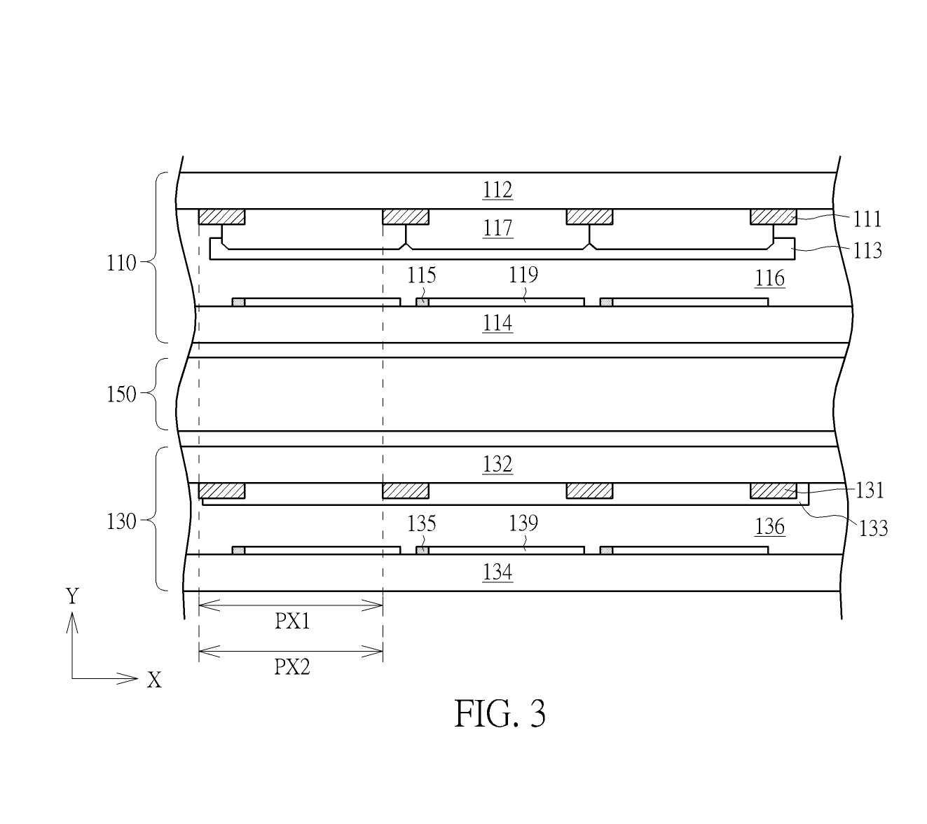

FIG. 3 is a partial schematic diagram illustrating a transparent display device according to a preferred embodiment of the present invention, wherein only a partial pixel region of each liquid crystal display panel is illustrated, in order to highlight the feature of the present invention. As shown in FIG. 3, the first display panel 110 includes a first black matrix pattern 111, the second display panel 130 includes a black matrix pattern 131, and the material of the first black matrix pattern 111 and the second black matrix pattern 131 may include chromium, chromium nitride, black resin, or other materials being good for light shielding and anti-reflective. The first black matrix pattern 111 is disposed at the surface of the first substrate 112, facing the second substrate 114, and the second black matrix pattern 131 is disposed at the surface of the third substrate 132, facing the fourth substrate 134. In a preferred embodiment, the first black matrix pattern 111 completely overlaps the second matrix pattern 131, as shown in FIG. 3. However, the present invention is not limited to this.

In another embodiment, the first black matrix pattern 111 can also be optionally disposed at the surface of the second substrate 114, facing the first substrate 112, and the second black matrix pattern 131 can also be optionally disposed at the surface of the fourth substrate 134, facing the third substrate 132, or other suitable positions. In addition, the first display panel 110 may further include a first common electrode 113, a plurality of first pixel electrodes 119, and a plurality of first TFTs 115; and the second display panel 130 may further include a second common electrode 133, a plurality of second pixel electrodes 139, and a plurality of second TFTs 135. The first common electrode 119 and the second common electrode 139 can be disposed on the surface of the second substrate 114, facing the first substrate 112, and the surface of the fourth substrate 134, facing the third substrate 132, respectively. The first common electrode 113 and the second common electrode 133 can cover the first black matrix pattern 111 and the second black matrix pattern 131 respectively. In the present embodiment, the first display panel 110 further includes a plurality of color filter patterns 117, covering the first black matrix pattern 111. Each of the first TFTs 115 is electrically connected to a corresponding first pixel electrode 119, each of the second TFTs 135 is electrically connected to a corresponding second pixel electrode 139, and each of the first TFTs 115 and each of the second TFTs 135 are disposed in an array arrangement (also known as matrix arrangement) to drive each of the first pixel electrodes 119 and each of the second pixel electrodes 139 respectively. Thus, the first display panel 110 and the second display panel 130 can be actively driven to show dynamic images.

The first black matrix pattern 111 defines a plurality of first pixel regions PX1 in the first display panel 110; the second black matrix pattern 131 define a plurality of second pixel regions PX2 in the second display panel 130, and each of the first pixel regions PX1 at least partially overlaps each of the second pixel regions PX2 in a projection direction perpendicular to the first active liquid crystal display panel 110 and the second active liquid crystal display panel 130. It is worth mentioning that, in the present embodiment, each of the first pixel regions PX1 completely overlaps each of the second pixel regions PX2 in the projection direction (referring to Y direction in the present embodiment), as illustrated in FIG. 3. Also, each of the first pixel regions PX1 and each of the second pixel regions PX2 have identical areas. In other words, the first display panel 110 and the second display panel 130 have the same pixel density, but the present invention is not limited thereto.

The transparent display panel of the present invention is not limited to the aforementioned embodiment. The following description will detail the other embodiments of the transparent display panel according to the present invention. To simplify the description, the following description will detail the dissimilarities among those embodiments and the identical features will not be redundantly described. In order to compare the differences between the embodiments easily, the identical components in each of the following embodiments are marked with identical symbols.

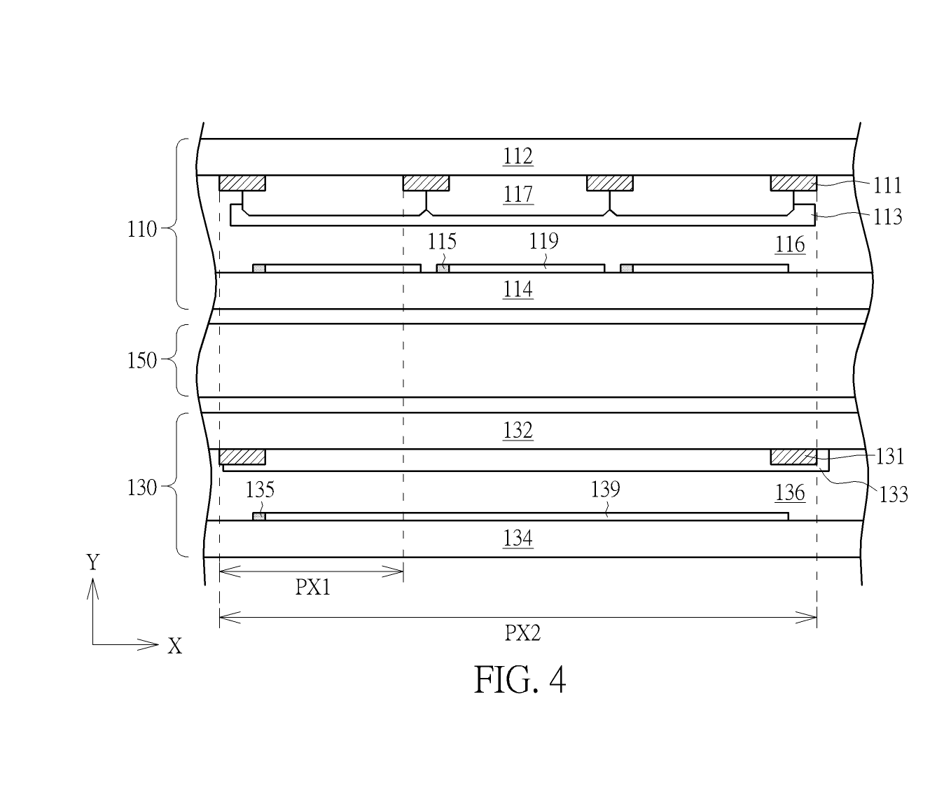

FIG. 4 is a partial schematic diagram illustrating another transparent display device according to a preferred embodiment of the present invention. In comparison with the aforementioned embodiment, the first display panel 110 and the second display panel 130 of the present embodiment have different pixel density, for example, each of the second pixel regions PX2 overlaps numbers of first pixel regions PX1, such as three of the first pixel region PX1, in the projection direction (referring to Y direction in the present embodiment) as illustrated in FIG. 4. However, the present invention is not limited thereto, and in other embodiment, it can also be more than one of the second pixel regions PX2 simultaneously overlapping one of the first pixel regions PX1 (not shown in the drawings).

Also, the arrangement and the material features of the first black matrix pattern 111, the second black matrix pattern 131, the color filter pattern 117, the first TFTs 115 and the second TFTs 135 have been fully described in the aforementioned embodiment, and which will not be redundantly described.

The transparent display device is mainly characterized in that the first display panel 110 and the second display panel 130 are cooperated with each other. Since both of the first display panel 110 and the second display panel 130 are an active LCD panel, both can show various images, such as color images, complete grayscale images or partial grayscale images, or various displaying states. Thus, the images shown by the first display panel 110 and the second display panel 130 can be observed simultaneously through the image display side of the transparent display device 10 of the present invention, with various images shown by the second display panel 130 facilitating the images shown by the first display panel 110 to achieve the purpose of improving the image contrast and the variety effect.

In addition, both of the first display panel 110 and the second display panel 130 include PDLC having low driving voltage and high image contrast, such that through adjusting the composition ratio of the PDLC, for example, with the PDLC including the PDLC composition and 20% to 50% of polymerized material, the driving voltage of the first display panel 110 and the second display panel 130 can be decreased to 5 ev. Wherein, the aforementioned polymerized material may include organic solvent, polyether polyol acrylic monomer, acrylic resin monomer, polymercaptan, and photoinitiator.

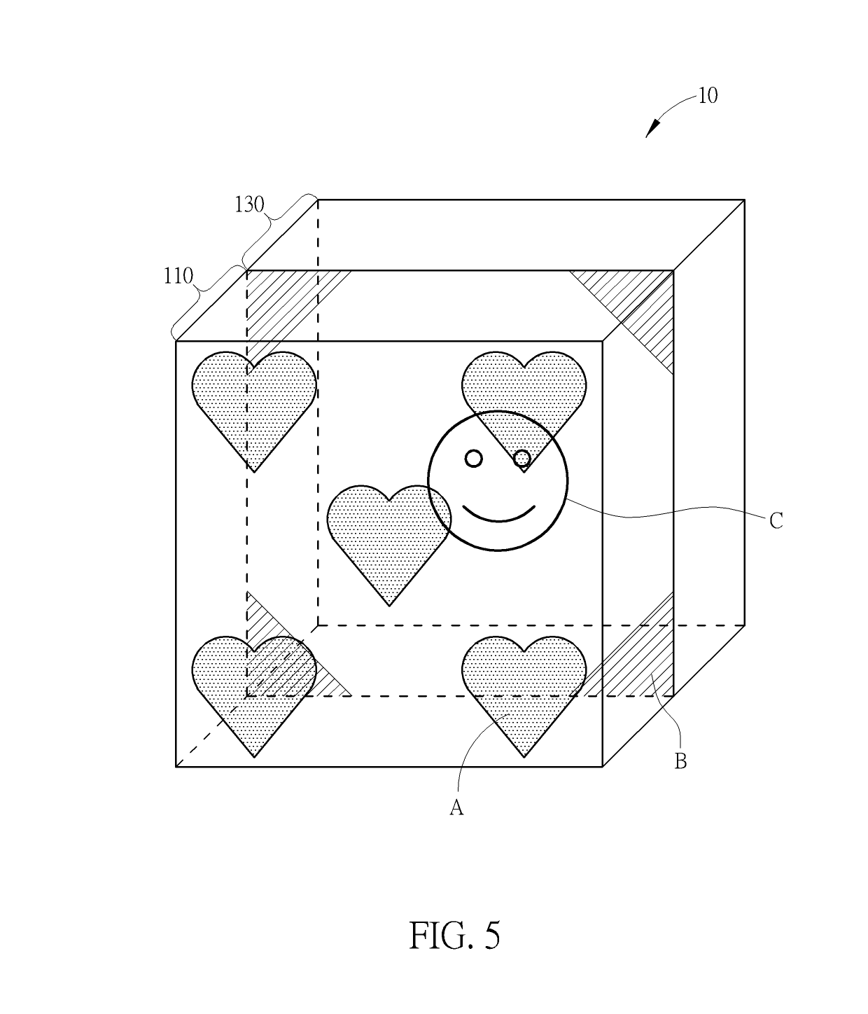

The following description will detail a displaying method of a transparent display device according to the present invention. Referring to FIGS. 5 to 10, FIGS. 5 to 10 are diagrams illustrating displaying methods of a transparent display device according to one embodiment of the present invention. Please note that, the figures are only for illustration, and the scale and the arrangement of partial components therein have been modified according to different design considerations, but the present invention is not limited thereto. In addition, when referring to a color image A, a full grayscale image B′, a partial grayscale image B and a background image C, it shall be well known in the art that those images describe the entire image effect shown by the display surface of the transparent display panel and which shall not be limited to the patterns shown in the drawings.

In the present embodiment, both of the first display panel 110 and the second display panel 130 are active liquid crystal display panels, and the first display panel 110 can be a color transparent liquid crystal display panel, preferably a color PDLC display panel; and the second display panel 130 can be a monochrome transparent display panel, preferably a monochrome PDLC display panel, but not limited thereto.

As shown in FIG. 5, the first display panel 110 of the transparent display device 10 according to the present embodiment provides a color image A, meanwhile, the second display panel 130 provides a partial grayscale image B, wherein, both of the color image A and the partial grayscale image B can be a dynamic image. With such performance, the partial grayscale image B only partially shields a background image C at the back surface (a surface opposite to the display surface) of the transparent display device 10 and facilitates the image displaying effect of the color image A. Thus, the transparent display device 10 of the present embodiment can show a composite image combining the patterns, wordings, grayscale and color. Accordingly, the transparent display device 10 of the present embodiment is capable of performing specific and diverse image displaying effects to be applied to a billboard or a video game machine.

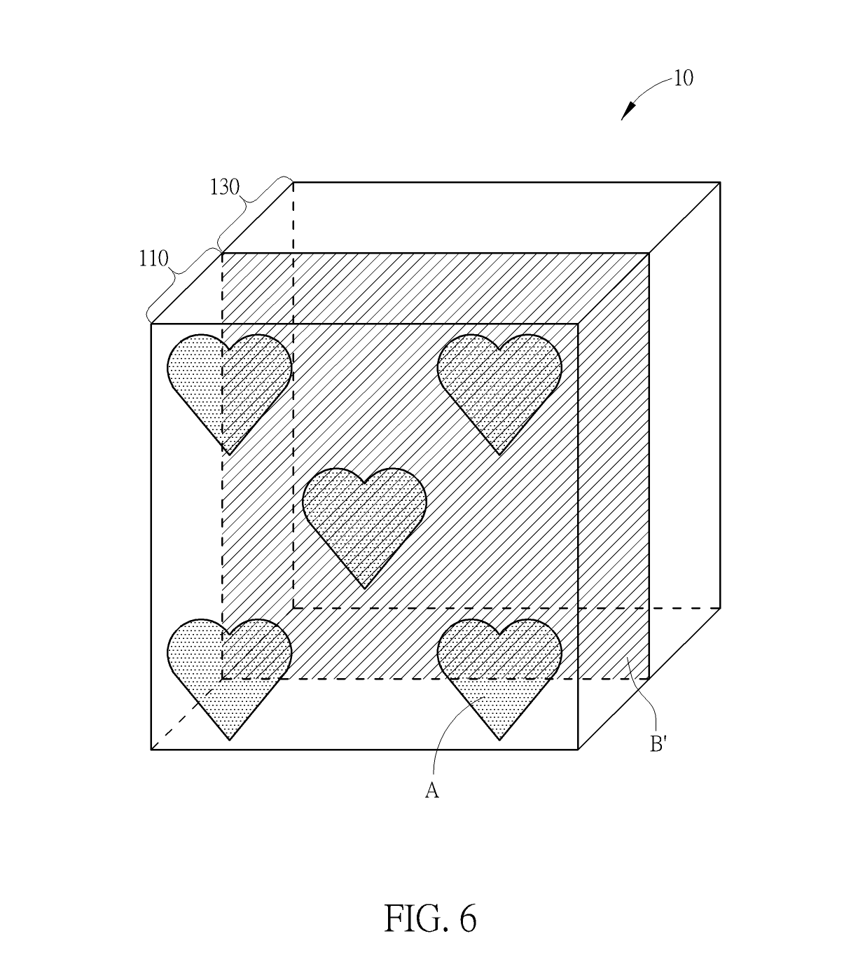

As shown in FIG. 6, the first display panel 110 of the transparent display device 10 according to the present embodiment provides the color image A, meanwhile, the second display panel 130 provides a full grayscale image B′, wherein, both of the color image A and the full grayscale image B′ can be a dynamic image. With such performance, the full grayscale image B′ will completely shield the background image C at the back surface (a surface opposite to the display surface) of the transparent display device 10. Thus, through completely shielding the background image C by the second display panel 130, it is sufficient to avoid the background image C interfering with the displaying of the color image A to increase the contrast of the color image A. Accordingly, the transparent display device 10 of the present embodiment can perform more clear and high contrast images.

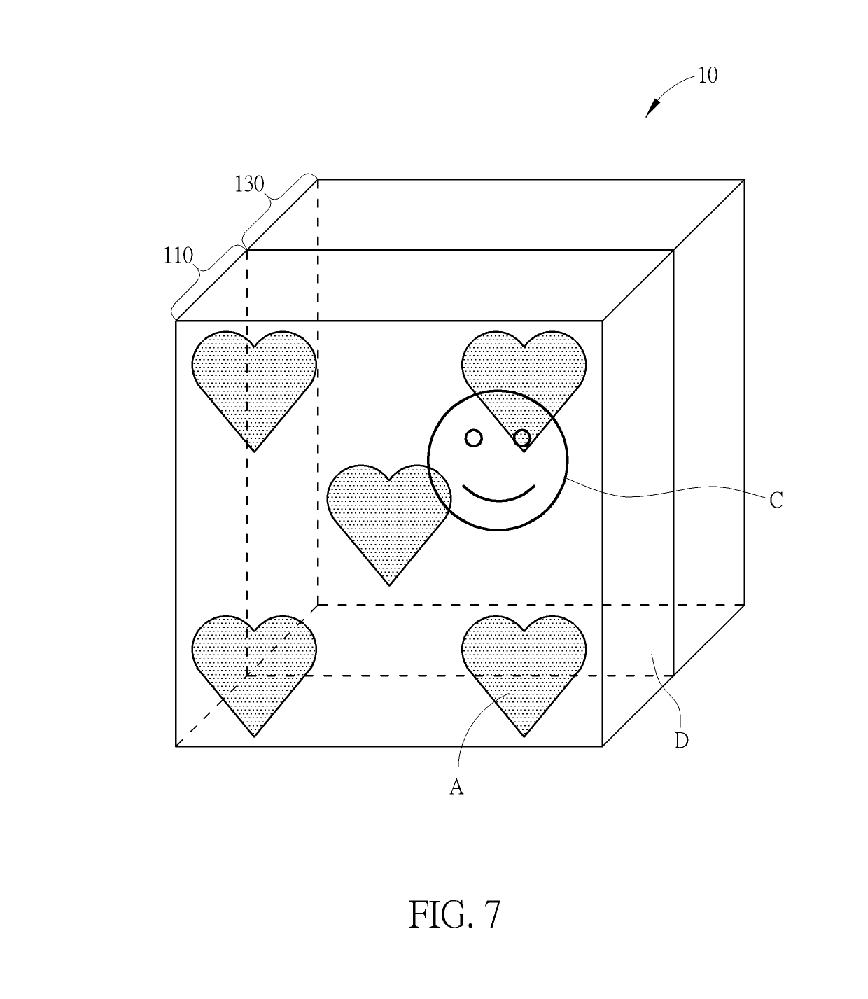

As shown in FIG. 7, the first display panel 110 of the transparent display device 10 according to the present embodiment provides the color image A, meanwhile, the second display panel 130 shows a transparent state D, wherein, the color image A can be a dynamic image. With such performance, the background image C can be directly observed through the display surface of the transparent display device 10. Thus, it is sufficient to facilitate the exhibition of the background image C through the color image A shown by the first display panel 110 to achieve the synergistic effect of the color image and the transparent state. Accordingly, the transparent display device 10 of the present embodiment is capable of being applied to a billboard or a video game machine.

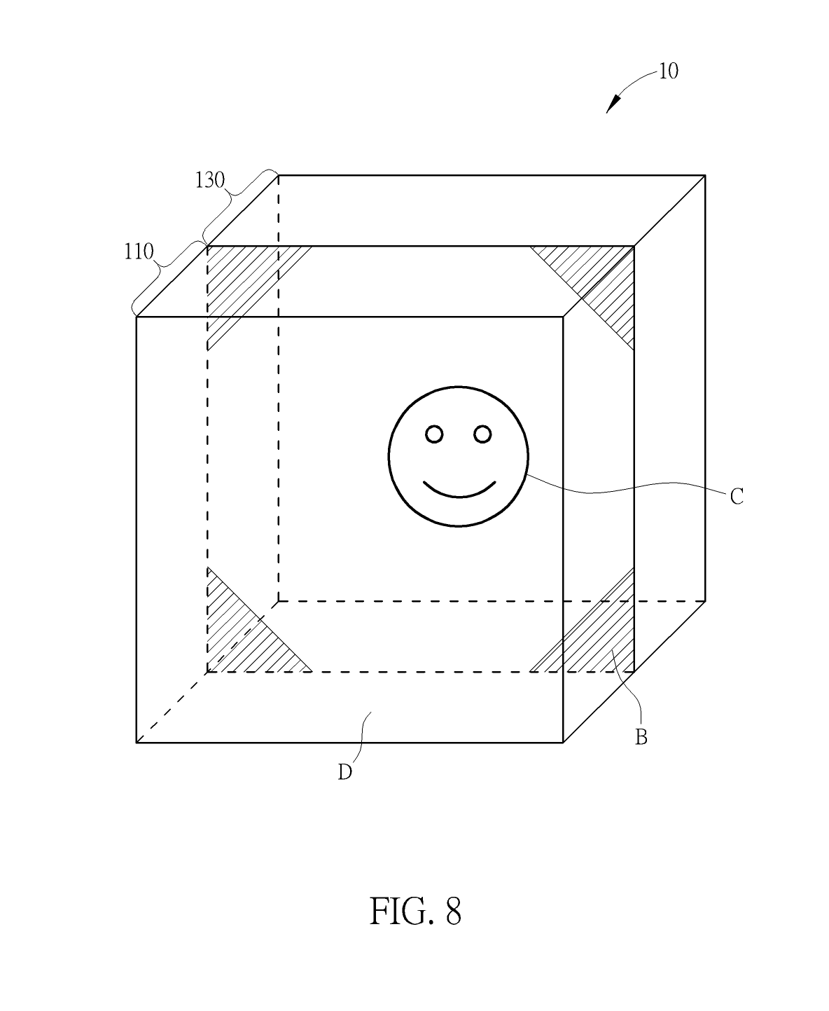

As shown in FIG. 8, the first display panel 110 of the transparent display device 10 according to the present embodiment shows the transparent state D, meanwhile, the second display panel 130 provides the partial grayscale image B, wherein, the partial grayscale image B can be a dynamic image. With such performance, the partial grayscale image B only partially shields the background image C, and the background image C can be observed partially through the display surface of the transparent display device 10. Thus, it is sufficient to facilitate the exhibition of the background image C through the partial grayscale image B shown by the second display panel 130. Accordingly, the transparent display device 10 of the present embodiment is capable of performing a partial shielding state to be applied to a showcase.

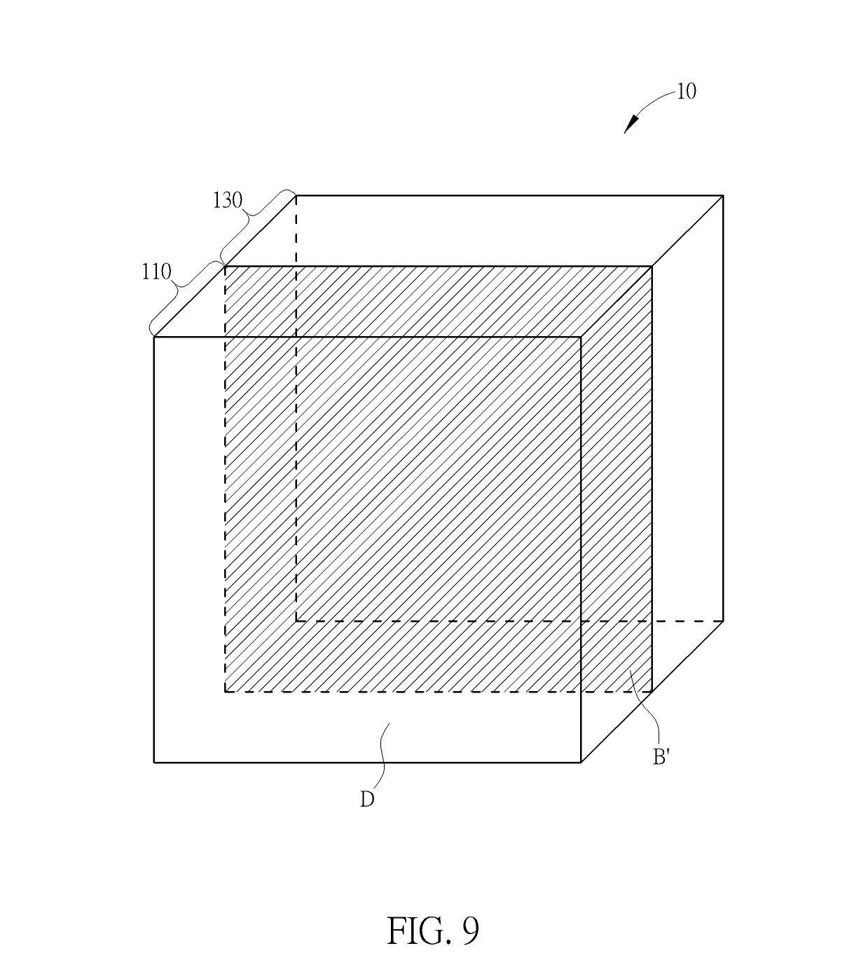

As shown in FIG. 9, the first display panel 110 of the transparent display device 10 according to the present embodiment shows the transparent state D, meanwhile, the second display panel 130 provides the full grayscale image B′. With such arrangement, the full grayscale image B′ can completely shield the background image C. Thus, through completely shielding the background image C by using the full grayscale image B′ shown by the second display panel 130, the transparent display device 10 of the present embodiment is capable of perform a shielding state, accordingly.

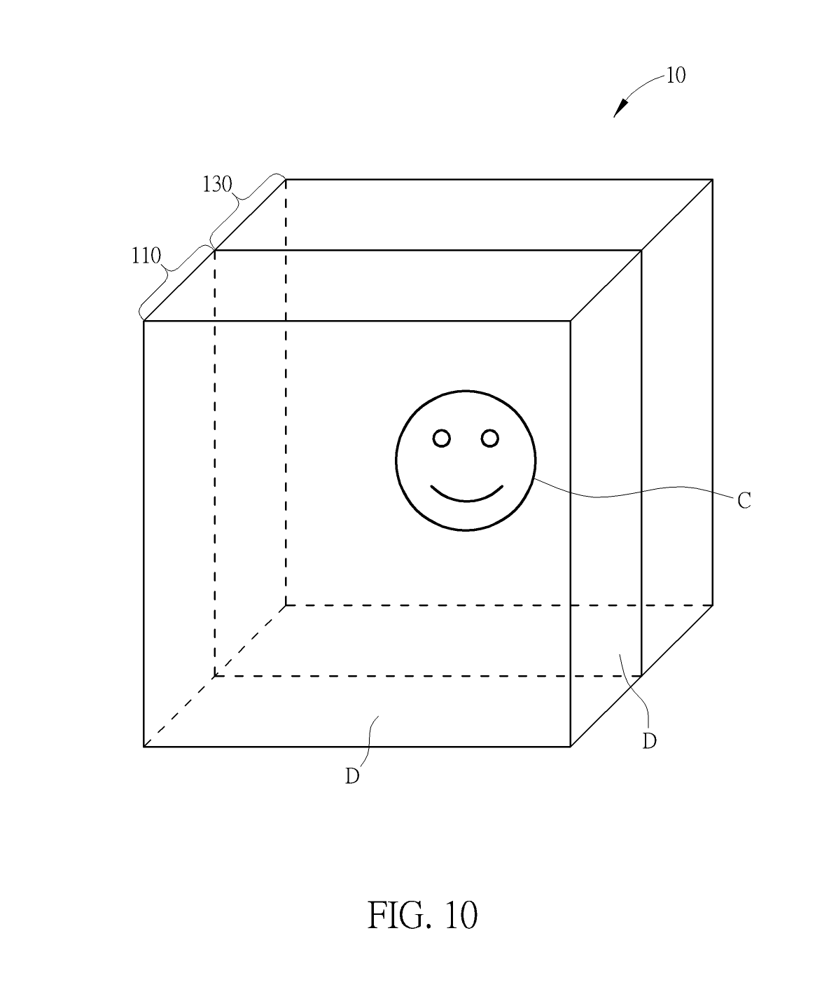

As shown in FIG. 10, the first display panel 110 of the transparent display device 10 according to the present embodiment shows the transparent state D, meanwhile, the second display panel 130 also shown the transparent state D. With such arrangement,

The background image C can be directly observed through the display surface of the transparent display device 10. Accordingly, the transparent display device 10 of the present embodiment can directly display the background image C at the back side thereof, with the transparent display device 10 of the present embodiment performing a full transparent state to be used as a showcase.

In summary, the transparent display device of the present invention is mainly characterized in the cooperation of the first active LCD display panel and the second active LCD display panel. The first active LCD panel and the second active LCD panel can show different images, such as color images, full grayscale images or partial grayscale images, or different displaying states, such as transparent state, respectively, with the images or displaying state shown by the second active LCD panel facilitating the images shown by the first active LCD panel to achieve the purpose of improving the image contrast and the variety effect. In addition, since both of the images shown by the first active LCD panel and the second active LCD panel can be a dynamic image, such as a dynamic color image or a dynamic grayscale image, the images displayed by the transparent display device of the present invention can be more diverse.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transparent display device, comprising:
a first active liquid crystal display (LCD) panel comprising a first display surface and a back surface opposite to the first display surface, the first active LCD panel further comprising:
a color filter substrate;
a first thin film transistor (TFT) substrate disposed opposite to the color filter substrate; and
a first polymer dispersed liquid crystal (PDLC) layer disposed between the color filter substrate and the first TFT substrate;
a second active LCD panel comprising a second display surface, the second display surface facing the back surface of the first active LCD panel, and the second active LCD panel further comprising:
a substrate;
a second TFT substrate disposed opposite to the substrate; and
a second PDLC layer disposed between the substrate and the second TFT substrate; and
a backlight module sandwiched between the first active LCD panel and the second active LCD panel.

2. The transparent display device according to claim 1, wherein the first active LCD panel further comprises a first black matrix pattern, the second active LCD panel further comprises a second black matrix pattern, and the first black matrix pattern overlaps the second black matrix pattern.

3. The transparent display device according to claim 2, wherein the first black matrix pattern defines a plurality of first pixel regions in the first active LCD panel, the second black matrix pattern defines a plurality of second pixel regions in the second active LCD panel, the first pixel regions of the first active LCD panel at least partially overlap the second pixel regions of the second active LCD panel in a projection direction perpendicular to the first active LCD panel and the second active LCD panel.

4. The transparent display device according to claim 3, wherein each of the first pixel regions completely overlaps each of the second pixel regions in the projection direction, and each of the first pixel regions and each of the second pixel regions have a same area.

5. The transparent display device according to claim 1, wherein the first active LCD panel and the second active LCD panel have a same pixel density.

6. The transparent display device according to claim 1, wherein a pixel density of the first active LCD panel is different from a pixel density of the second active LCD panel.

7. The transparent display device according to claim 1, wherein the backlight module comprises at least one light source and a transparent light guide plate, and the light source is at least disposed at a side of the transparent light guide plate.

8. A displaying method of a transparent display device, comprising:
providing the transparent display device according to claim 1;
showing a color image or showing a transparent state through the first active LCD panel; and
showing a partial grayscale image or a full grayscale image, or showing a transparent state through the second active LCD panel.

9. The displaying method of the transparent display device according to claim 8, wherein the color image is a dynamic image.

10. The displaying method of the transparent display device according to claim 8, wherein both of the first active LCD panel and the second active LCD panel show the transparent state, such that the transparent display device displays a full transparent state.

11. The displaying method of the transparent display device according to claim 8, wherein the first active LCD panel shows the color image, and the second active LCD panel shows the full grayscale image, for improving a contrast of the color image.

12. The displaying method of the transparent display device according to claim 8, wherein the first active LCD panel shows the color image, and the second active LCD panel shows the partial grayscale image, for improving a displaying effect of the color image.

13. The displaying method of the transparent display device according to claim 12, wherein the partial grayscale image is a dynamic image.

14. The displaying method of the transparent display device according to claim 8, wherein the first active LCD panel shows the color image, and the second active LCD panel shows the transparent state, thereby providing a synergistic effect of the color image and the transparent state.

15. The displaying method of the transparent display device according to claim 8, wherein the first active LCD panel shows the transparent state, and the second active LCD panel shows the full grayscale image, for providing a shielding state.

16. The displaying method of the transparent display device according to claim 8, wherein the first active LCD panel shows the transparent state, and the second active LCD panel shows the partial grayscale image, for providing a partial shielding state.

17. The displaying method of the transparent display device according to claim 16, wherein the partial grayscale image is a dynamic image.
